(19) United States
(12) Patent Application Publication
(10) Pub. No.: US 2006/0017541 A1
(43) Pub. Date: Jan. 26, 2006

(54) Tracking by radio frequency identification

(76) Inventor: Martin Khang Nguyen, Westminster, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/897,189

(22) Filed: Jul. 22, 2004

(51) Int. Cl. G05B 19/00; G06K 5/00

(52) U.S. Cl. 340/5.81; 340/5.86; 235/382

(57) ABSTRACT

The invention is a technique to provide security. A pass has primary information on a person to allow the person to enter an area. A first radio frequency identification (RFID) tag attached to the pass contains supplemental information regarding the person. The supplemental information capable of being read by at least an RFID reader located in the area.

### BACKGROUND

1. Field of the Invention

Embodiments of the invention relates to the field of radio frequency identification (RFID), and more specifically, to locating by RFID.

2. Description of Related Art

Security has been an important aspect of many activities that involve mass population. This is especially significant in light of recent terrorist activities. Activities that involve mass population may include travel, entertainment, sports, meeting, public gatherings, movie theaters, school campus, work place, convention, and theme parks activities, etc. Security concerns may include identification of people, tracking people, locating lost items or children or even adults.

Techniques to enhance security and convenience for the public in mass activities either do not exist or have a number of drawbacks. People usually have to wait in long lines to go through security check. Checked-in items such as luggage, personal belongings may be stolen, lost, or forgotten. In addition, in them park activities, children may get lost.

### BRIEF DESCRIPTION OF THE DRAWINGS

The invention may best be understood by referring to the following description and accompanying drawings that are used to illustrate embodiments of the invention. In the drawings:

FIG. 1 is a diagram illustrating a system in which one embodiment of the invention can be practiced.

FIG. 2 is a diagram illustrating a pass assembly according to one embodiment of the invention.

FIG. 3 is a diagram illustrating an item matching according to one embodiment of the invention.

FIG. 4 is a diagram illustrating a tracking system according to one embodiment of the invention.

FIG. 5 is a diagram illustrating a locating area according to one embodiment of the invention.

### DESCRIPTION

An embodiment of the present invention is a technique to track information of a person entering an area of security concerns. A pass has primary information on a person to allow the person to enter the area. A first radio frequency identification (RFID) tag is attached to the pass and contains supplemental information regarding the person. The supplemental information is capable of being read by at least an RFID reader located in the area.

Another embodiment of the invention is a technique to track people or item using radio frequency identification (RFID). Information transmitted by a radio frequency identification (RFID) tag associated with a person or an item from a first location in an area is received by a first RFID reader located at a first reader location. The first RFID reader has a first range. The first location is determined using the first reader location and the first reader range.

In the following description, numerous specific details are set forth. However, it is understood that embodiments of the invention may be practiced without these specific details. In other instances, well-known circuits, structures, and techniques have not been shown in order not to obscure the understanding of this description.

One embodiment of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc.

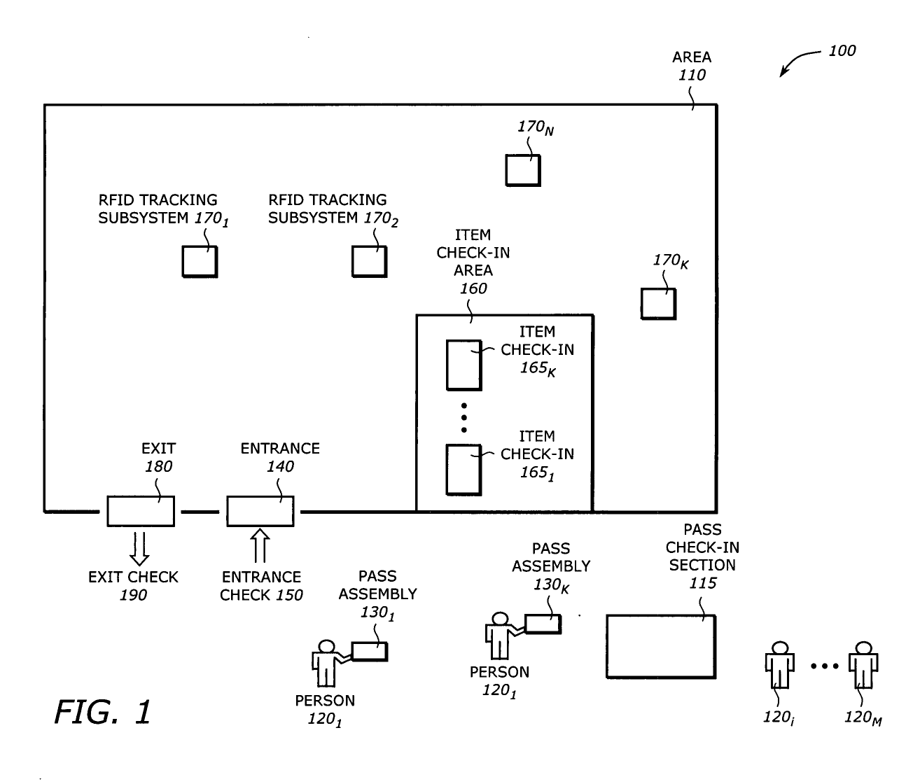

FIG. 1 is a diagram illustrating a system 100 in which one embodiment of the invention can be practiced. The system 100 includes an area 110, a pass check-in section 115, and a plurality of persons 120₁ to 120_{M}. The system 100 represents a scenario that involves a large number of people. This scenario may be a routine activity (e.g., travel), a regular event (e.g., convention, theme park, sports event), or a rare event (e.g., demonstration).

The plurality of persons 120₁ to 120_{M} are people who intend to enter the area 110. They may also be passengers who travel by air, bus, train, ship, or any other mass transportation means. They may also be theater, movie, church, sports event, theme park goers, etc. They may be participants or audience in an event such as concert, sport event, parade, meeting, demonstration, rally, celebration, etc.

In order to enter the area 110, the plurality of persons 120₁ to 120_{M} obtains pass assemblies 130₁ to 130_{M} at the pass check-in section 115. Each of the pass assemblies provides evidence that its holder is given authorization to enter the area 110 either by satisfying some screening criteria or status or by paying an admission fee (e.g., ticket) or cost of activity (e.g., airline or bus ticket). The screening criteria may include credentials or identification of authorized people such as members of the press, staff, organization personnel, performers, security personnel, etc. Each of the pass assemblies 130₁ to 130_{M} contains a first RFID tag that can be read or tracked by RFID tracking subsystems in the area 110.

The pass check-in section 115 is an area where the plurality of persons 120₁ to 120_{M} obtain pass assemblies 130₁ to 130_{M} to enter the area 110. It may be a ticket counter of an airline at the airport, a theater, a theme park, etc. It may also be a registration desk at a convention, a hotel, a parade, a public meeting, etc. In some situations, the plurality of persons 120₁ to 120_{M} may be asked to present identification in order to obtain the pass assemblies. The pass assemblies may also be obtained in advance by some or all of the plurality of persons 120₁ to 120_{M}. Those who already obtain the pass assembly may be allowed to proceed to the entrance 140.

The area 110 is an area restricted to people who are allowed to enter. It may be any area that is used for mass activities. It may be an airport, a mass transportation station (e.g., a bus station, train station), a passenger area, a concert place, a sport stadium, a theme park, a building, a theater, a meeting place, a campus, a public area, a private area, a hotel, a church, a theater, an open or closed space reserved for an event, etc. It includes an entrance 140, an item check-in area 160, a plurality of RFID tracking subsystems 170₁ to 170_{N}, and an exit 180.

The entrance 140 allows people who have valid passes or tickets for the activities to enter the area 110. It typically has an entrance check-in station 150. Security personnel or event organizer workers are at the check-in station 150 to check or inspect people to determine if they are allowed to enter the area 110. They also check to ensure that nobody is allowed to exit the area 110. The specific arrangement depends on the mass activities. At the airport, the check-in station 150 may include the area where security personnel check the passenger's identification (e.g., driver's license, passports, boarding pass), the metal detector gates, and the X-ray machines. At a theme park, the check-in station 150 may include park personnel to check the tickets of patrons. In some cases, the check-in station 150 may have no personnel and only include automatic gates or turnstiles that automatically turn open to allow a person to go through the entrance 140 if a pass or ticket has been verified.

The item check-in area 160 is an area where items 165₁ to 165_{K} belonging to the persons who intend or are allowed to enter the area 110 are checked in. When a person checks an item, he or she typically presents attachment information to be entered in a second RFID tag to be attached to the item. The attachment information is later checked or verified with the information in the RFID tag of the pass assembly. At the airport, the item check-in area 160 may be at the ticket counter or at the luggage check-in area where passengers check in their luggage. At a theater, the item check-in area 160 may be an item check-in counter where theater goers check in their personal belongings such as coats, garments, cameras, computers, umbrellas, hats, etc. The item check-in area 160 may not be present in some scenarios.

The plurality of RFID tracking subsystems 170₁ to 170_{N} are installed inside the area 110 to track the RFID tags of the pass assemblies. They are located at pre-defined or movable locations such that locations of the RFID tags may be identified. Since the RFID tag is part of the pass assembly which is supposed to be held by the respective person, the location of the RFID tag also provides location of the person who holds the pass assembly.

The exit 180 is where the persons 120₁ to 120_{M} leave the area 110. It has an exit check 190. Security personnel or organizer staff are at the exit check 190 to ensure that nobody is allowed to enter the area 110. There may be several exits like the exit 180 located around the area 110. Any person who leaves the area 110 may be asked to return his or her pass assembly or the RFID tag on his or her pass assembly to the security personnel. In some situations where the RFID tag on the pass assembly may be re-used, the person leaving the area 110 may be allowed to keep his or her pass assembly or the associated RFID tag.

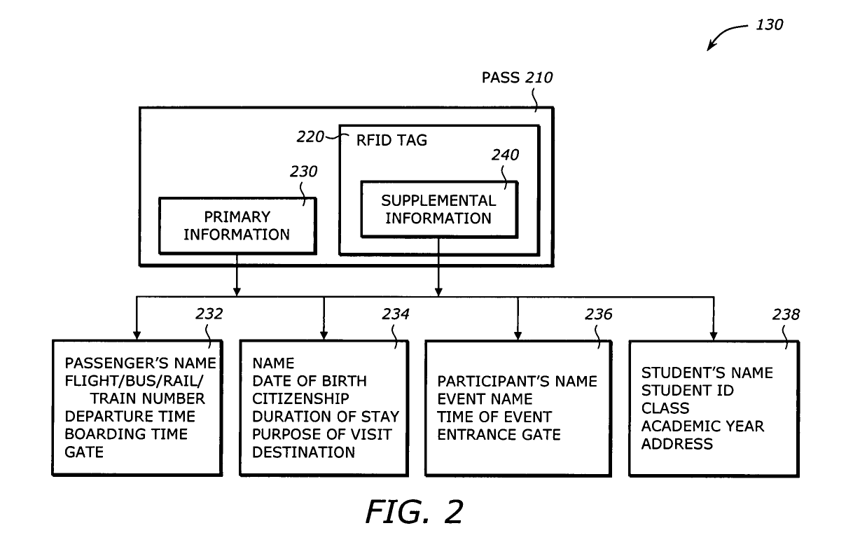

FIG. 2 is a diagram illustrating a pass assembly 130 according to one embodiment of the invention. The pass assembly 130 is representative of the pass assemblies 130₁ to 130_{M}. It includes a pass 210 and an RFID tag 220.

The pass 210 has primary information on a person to allow the person to enter the area 110. It may be a boarding pass, a passport, an event pass for an event, a mass transportation ticket, a school pass, a meeting pass, and an entrance pass. The event may be a concert, a sport event, an entertainment event, a rally, a political event, a theatrical event, a game event, a meeting event, a demonstration event, a celebration event, a parade, etc. The pass 210 may be obtained in advance or at the pass check-in section 115. For example, a boarding pass may be obtained at home or at self-served kiosks or counters located outside the area 110.

The primary information typically includes at least identification information on the person holding the pass assembly, event information, travel information, duration of stay, destination information, mass transportation information, school information, meeting information, and event information. Examples of the primary information include boarding information 232, passport information 234, event information 236, and school information 238. The boarding information 232 includes passenger's name, flight/bus/train number, departure time, boarding time, and gate number. The passport information 234 includes name, date of birth, citizenship, duration of stay, purpose of visit, destination, and any other pertinent information. The event information 236 include event name (e.g., movie, meeting title), time of event, entrance gate, or participant's name. The school information 238 includes student's name, student identification code, class, academic year, address, and any other pertinent information.

The RFID tag 220 contains supplemental information 240. The tag 220 may employ active or passive RFID technology. The tag 220 has unique anti-collision capabilities so that the transmitted RF information is not interfered by or interferes RF information transmitted by other tags. The tag 220 may be designed to facilitate attachment to the pass 210. It may be integrated with the pass 210 and become an integral member of the pass assembly 130. It may be a detachable or removable tag. The tag 220 may operate in any suitable frequency. It may also receive RF information. The tag information data and/or the configuration setup are not affected by other electromagnetic signals (e.g., x-rays). In one embodiment, the tag 220 is an active tag that transmits RF information between approximately 800 MHz to 950 MHz and receives RF information between approximately 300 MHz to 600 MHz. The frequency ranges are merely for illustrative purposes. It is contemplated that any frequency ranges can be used. If the tag 220 is an active tag, it is normally in a sleep mode until awaken by a field provided by a field generator. The wake-up range may be from about one meter to hundreds of meters depending on the strength of the field generator. The real range for the RF tag information may be up to hundreds of meters depending on the sensitivity and/or strength of the tag reader. The tag 220 may be powered by any convenient power source including lithium battery.

The supplemental information 240 is coded according to a pre-defined code as provided by the manufacturer of the RFID tag. The supplemental information 240 may contain information similar to the primary information described above. Typically, the supplemental information 240 contain mainly the information pertinent to the person holding the pass assembly 130 while the primary information 230 contains mainly the information pertinent to the particular event or activity taken place in the area 110 that the person enters.

The supplemental information 240 and the primary information 230 may be mutually exclusive or they may share some common information. In one embodiment, at least part of the primary information 230 matches with part of the supplemental information 240. In one embodiment, part of the supplemental information 240 matches with attachment information that is contained in a second RFID tag that is attached to an object belonging to the person. The object may be one of the items 165₁ to 165_{K} (FIG. 1) that is checked in by the holder of the pass assembly at the check-in area 160.

The pass 210 may also be used to attach to an item carried by the person entering the area 110. It may be duplicated or the primary information may be different than the primary information on the pass 210 that is carried on the person. Examples of items that may have their own pass or RFID tag include the carry-on luggage of a passenger, a brief case, an equipment, a personal item, a student's bag, etc. The pass or tag that is attached to the item carried by the person contains information or identifier that is matched with that of the pass carried on the person, or the second RFID tag that is attached to the items 165ₖ that the person checks in. By attaching an RFID tag on the personal item carried into the area 110, items may be tracked the same way as the person. Lost items, therefore, may be found quickly.

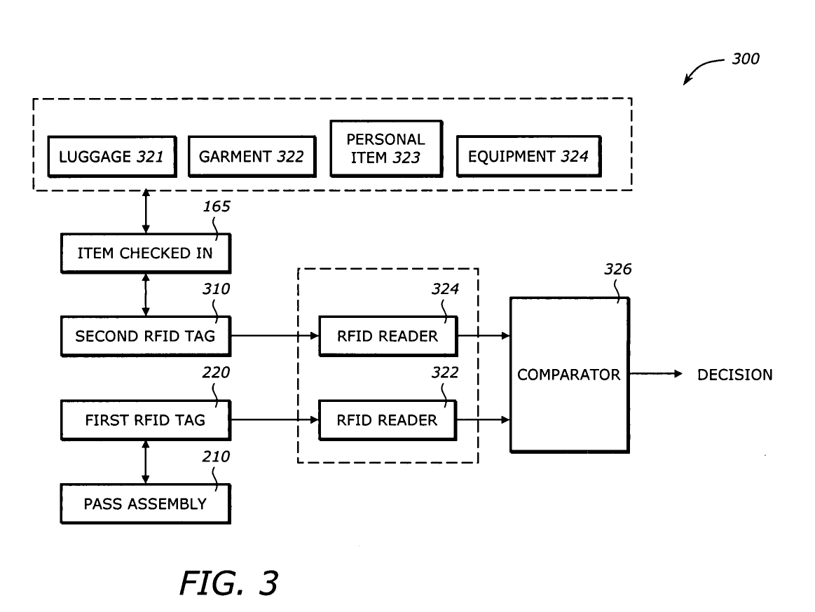

FIG. 3 is a diagram illustrating an item matching 300 according to one embodiment of the invention. The item matching 300 includes a verifier/matcher 320.

The verifier/matcher 320 matches a second RFID tag 310 attached to the checked-in item 165 with the first RFID tag 220 on the pass assembly 210 and generates a decision. The checked-in item 165 may be a luggage 321, a garment 322, a personal item 323, or an equipment 324. The verifier/matcher 320 includes RFID readers 322 and 324 and a comparator 326. The RFID reader 322 reads the first RFID tag 220 to obtain the supplemental information. It may be part of the RFID tracking subsystem installed at the gate area. The RFID readers 322 and 324 may be the same or different. The RFID reader 324 reads the second RFID tag 310 to obtain the attachment information. Typically, the supplemental information and the attachment information share some common information such as the identification information of the holder of the pass assembly. The comparator 326 compares the two information to determine if there is a match and generates a decision. The particular decision depends on the scenario under which the item matching 300 takes place.

The item matching 300 may occur under a number of scenarios. In a mass transportation scenario, a passenger checks in his or her luggage at the check-in area 160. The check-in clerk weighs the luggage and attaches the second RFID tag 310 to the luggage. The second RFID tag 310 contains attachment information that may identify the passenger and his or her travel information such as flight number, destination, etc. The passenger then obtains the pass assembly with the first RFID tag 220 and enters the boarding area through the entrance 140. The luggage is then loaded into the plane, bus, or train and the attachment information is read by the second RFID reader 324. When the passenger boards the plane, bus, or train, the supplemental information on the first RFID tag 220 is read by the first RFID reader 322. In a typical scenario, there are a number of checked in luggage and a number of passengers. If it is determined that a luggage is checked in, but its owner or the passenger holding the corresponding pass assembly does not board the plane/bus/train, then the decision may be to unload the luggage. This is to avoid several problems. One problem is a scenario in which a terrorist checks in his or her luggage that may contain explosives and does not board the plane. Another problem is a scenario in which the passenger misses the plane although his or her luggage has been checked in. By ensuring that a luggage is only loaded into the airplane that carries its owner, luggage loss or terrorist attack may be avoided.

In a theater scenario, when a patron checks in his or her coat at the check-in counter, the check-in clerk attaches the RFID tag 310 to the coat. The patron then obtains the pass assembly and enter the theater, carrying the RFID tag 220. Suppose the patron leaves the theater and forgets to retrieves his or her coat. He or she returns the RFID tag 220 at the exit. At that time, the verifier/matcher 320 determines that the patron is leaving without checking out the coat. The decision may be to alert the theater personnel at the exit gate to inform the patron that he or she forgets to obtain the coat.

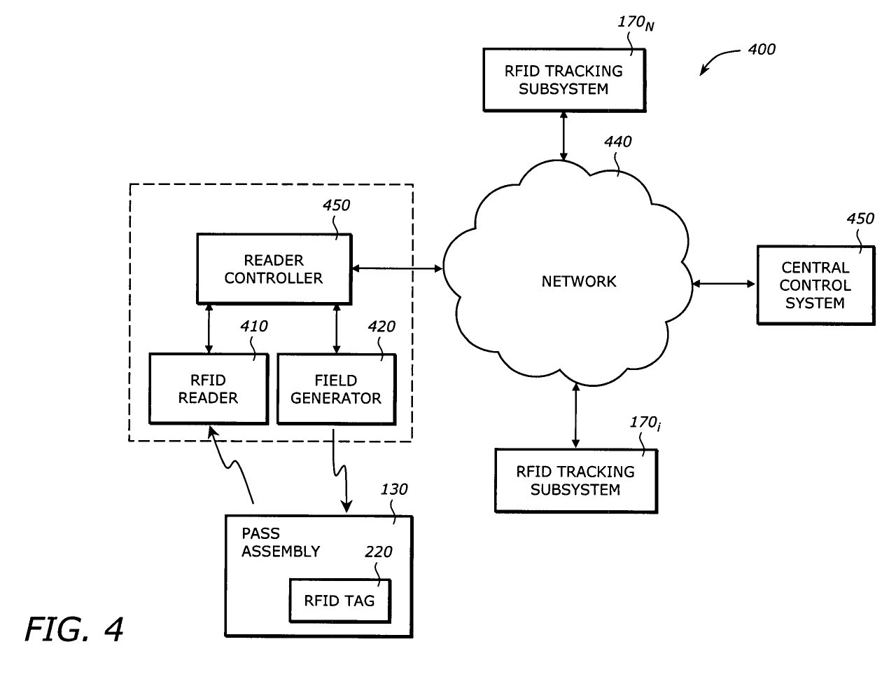

FIG. 4 is a diagram illustrating a tracking system 400 according to one embodiment of the invention. The tracking system 400 includes N RFID tracking subsystems 170₁ to 170_{N} in the area 110, a network 440, and a central control system 450.

The RFID tracking subsystem 170₁ is representative of the N RFID tracking subsystems 170₁ to 170_{N}. It includes a RFID reader 410, a field generator 420, and a reader controller 430.

The RFID reader 410 reads the supplemental information transmitted by the RFID tag 220 when it is awaken by the field generator 420. The reader 410 reads the RF information at the frequency ranges operated by the corresponding RFID tag. It also has a wired or wireless connection to a host computer that connects to the network 440 or directly to the central control system 450. The read range of the reader 410 depends on the setting. It may read from about one meter or less up to several hundred meters.

The field generator 420 generates a field within a distance from the RFID tracking subsystem 1701 to awaken the RFID tag 220 on the pass assembly 130. The distance may be set in advance at some pre-defined distance. In one embodiment, the distance is between 1 meter to 30 meters. The field frequency may be any suitable frequency to wake up the RFID tag. In one embodiment, the field frequency ranges from 200 MHz to 600 MHz. The field strength may be adjusted accordingly for a specified wake-up range.

When the RFID tag 220 enters the field generated by the field generator 420, it is awaken and transmits the supplemental information to the RFID reader by radio frequency. The RFID reader 410 obtains the supplemental information and sends it to the reader controller 430.

The reader controller 430 controls the field generator 420 and the RFID reader 410. The reader controller 430 may be a host computer that has appropriate programs to process the data read by the RFID reader 410. It may communicate with the reader 410 via wired or wireless means. It has interface to the network 440.

The network 440 may be any suitable network. It may be a local area network (LAN), a wide area network (WAN), a intranet, or an internet. It may also be an RF space where wireless transmissions may take place. It provides the means and medium for the N RFID tracking subsystems 170₁ to 170_{N} to transmit and receive information to and from the central control system 450.

The central control system 450 collects the RFID information transmitted by the N RFID tracking subsystems 170₁ to 170_{N} and process the information. One useful process is tracking the location of the RFID tag 220, which in turn provides information of the holder of the tag 220. This function is useful in locating lost people such as children or any suspicious activity.

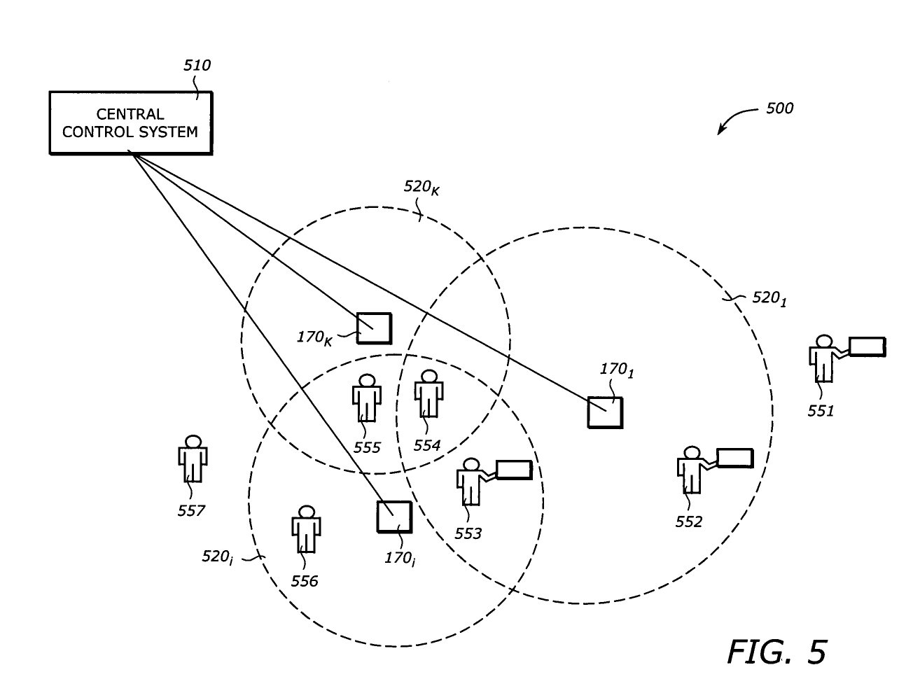

FIG. 5 is a diagram illustrating a locating area 500 according to one embodiment of the invention. The locating area 500 provides an example on how a person is located using the RFID tracking subsystems.

For illustrative purposes, three RFID tracking subsystems 170₁, 170ᵢ and 170ₖ are shown. They are connected to the central control system 450 through the network 440 (not shown). Each of the three RFID tracking subsystems 170₁, 170ᵢ and 170ₖ may have the same or different field distances. The field distance defines a locating periphery or area within which the field is active. Any RFID tag 220 within the active field area may be awaken and transmits the supplemental information continuously or periodically. The three RFID tracking subsystems 170₁, 170ᵢ and 170ₖ have the active field peripheries 520₁, 520ᵢ and 520ₖ, respectively.

By integrating the RFID supplemental information transmitted by the RFID tag 220, the central control system 510 may determine the location of the RFID tag 220. For example, at location 551, the RFID tag 220 is outside of all three fields and its location may be determined through prior knowledge of the previously integrated information. At location 552, the RFID tag 220 is read only by the RFID tracking subsystem 170₁. Therefore its location is determined to be within the periphery 520₁. At location 553, the RFID tag 220 is read by the tracking subsystems 170₁ and 170ᵢ. Therefore, its location is determined to be within the area intersected by the periphery 520₁ and 520ᵢ. This intersection area provides a more specific location information. In general, the more the peripheries are overlapped, the more accurate the location is determined. At location 554, the RFID tag 220 is read by all three tracking subsystems 170₁, 170ᵢ and 170ₖ. Therefore, its location is determined to be within the intersection of the three peripheries 520₁, 520ᵢ and 520ₖ.

The central control system 450 may also perform complex movement tracking to follow the path that the person holding the RFID tag 220 is traversing. This may be determined or estimated based on the typical movement speed of a person and the previous location points.

By tagging and attaching RFID tags to mobile personal items, checked-in items, and/or to a pass assembly held by the person, many security activities or convenient and efficient tracking may be carried out. Lost items or people may be located efficiently and quickly. People may be tracked to determine their movement and/or location in the area 110. Students may be tracked to determine if they are within a campus area. Their class attendance may be efficiently kept tracked of. The location and/or movement information may be transferred to the central control system 450. The central control system 450 may post the information on a Website so that the information may be looked up in real-time. Parents at home may check the attendance of their children at school by logging onto the Website. People may check the attendance and/or presence of their relatives in the area 110. The applications and scenarios are numerous.

The advantages of the invention include: (1) accurate tracking of people or items in a secure area, (2) fast and efficient locating people or items, (3) effective dissemination of information about people in a secure are and (4) convenience for the people entering a secure area.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. An apparatus comprising:
a pass having primary information on a person to allow the person to enter an area; and
a first radio frequency identification (RFID) tag attached to the pass and containing supplemental information regarding the person, the supplemental information capable of being read by at least an RFID reader located in the area.

2. The apparatus of claim 1 wherein the pass is one of a boarding pass, a passport, an event pass for an event, a mass transportation ticket, a school pass, a meeting pass, and an entrance pass.

3. The apparatus of claim 2 wherein the event is one of a concert, a sport event, an entertainment event, a rally, a political event, a theatrical event, a game event, a meeting event, a demonstration event, a celebration event, a parade.

4. The apparatus of claim 2 wherein the area is one of an airport, a mass transportation station, a passenger area, a concert place, a sport stadium, a theme park, a building, a theater, a meeting place, a campus, a public area, a private area, a hotel, a church, a theater, an open or closed space reserved for the event

5. The apparatus of claim 1 wherein the primary information includes at least identification information on the person, event information, travel information, duration of stay, destination information, mass transportation information, school information, meeting information, and event information.

6. The apparatus of claim 1 wherein the supplemental information includes at least identification information on the person, event information, travel information, duration of stay, destination information, mass transportation information, school information, meeting information, and event information.

7. The apparatus of claim 1 wherein at least part of the primary information matches with part of the supplemental information.

8. The apparatus of claim 1 wherein part of the supplemental information matches with attachment information that is contained in a second RFID tag that is attached to an object belonging to the person.

9. The apparatus of claim 7 wherein the object is one of a luggage, a garment, a personal item, and an equipment.

10. The apparatus of claim 1 wherein the at least RFID reader is located within a predetermined distance from the first RFID tag.

11. A method comprising:
providing a pass having primary information on a person to allow the person to enter an area; and
attaching a first radio frequency identification (RFID) tag to the pass, the first RFID tag containing supplemental information regarding the person, the supplemental information capable of being read by at least an RFID reader located in the area.

12. The method of claim 11 wherein the pass is one of a boarding pass, a passport, an event pass for an event, a mass transportation ticket, a school pass, a meeting pass, and an entrance pass.

13. The method of claim 12 wherein the event is one of a concert, a sport event, an entertainment event, a rally, a political event, a theatrical event, a game event, a meeting event, a demonstration event, a celebration event, a parade.

14. The method of claim 12 wherein the area is one of an airport, a mass transportation station, a passenger area, a concert place, a sport stadium, a building, a theater, a meeting place, a campus, a public area, a private area, a hotel, a church, a theater, an open or closed space reserved for the event

15. The method of claim 11 wherein the primary information includes at least identification information on the person, event information, travel information, duration of stay, destination information, mass transportation information, school information, meeting information, and event information.

16. The method of claim 11 wherein the supplemental information includes at least identification information on the person, event information, travel information, duration of stay, destination information, mass transportation information, school information, meeting information, and event information.

17. The method of claim 11 wherein at least part of the primary information matches with part of the supplemental information.

18. The method of claim 11 wherein part of the supplemental information matches with attachment information that is contained in a second RFID tag that is attached to an object belonging to the person.

19. The method of claim 17 wherein the object is one of a luggage, a garment, a personal item, and an equipment.

20. The method of claim 11 wherein the at least RFID reader is located within a predetermined distance from the first RFID tag.

21. A system comprising:
at least a radio frequency identification (RFID) reader located in an area; and
a pass assembly to allow a person to enter the area, the pass assembly comprising:
a pass having primary information on a person to allow the person to enter an area, and
a first radio frequency identification (RFID) tag attached to the pass and containing supplemental information regarding the person, the supplemental information capable of being read by at least an RFID reader located in the area.

22. The system of claim 21 wherein the pass is one of a boarding pass, a passport, an event pass for an event, a mass transportation ticket, a school pass, a meeting pass, and an entrance pass.

23. The system of claim 22 wherein the event is one of a concert, a sport event, an entertainment event, a rally, a political event, a theatrical event, a game event, a meeting event, a demonstration event, a celebration event, a parade.

24. The system of claim 22 wherein the area is one of an airport, a mass transportation station, a passenger area, a concert place, a sport stadium, a building, a theater, a meeting place, a campus, a public area, a private area, a hotel, a church, a theater, an open or closed space reserved for the event

25. The system of claim 21 wherein the primary information includes at least identification information on the person, event information, travel information, duration of stay, destination information, mass transportation information, school information, meeting information, and event information.

26. The system of claim 21 wherein the supplemental information includes at least identification information on the person, event information, travel information, duration of stay, destination information, mass transportation information, school information, meeting information, and event information.

27. The system of claim 21 wherein at least part of the primary information matches with part of the supplemental information.

28. The system of claim 21 wherein part of the supplemental information matches with attachment information that is contained in a second RFID tag that is attached to an object belonging to the person.

29. The system of claim 27 wherein the object is one of a luggage, a garment, a personal item, and an equipment.

30. The system of claim 21 wherein the at least RFID reader is located within a predetermined distance from the first RFID tag.
